(19) United States
(12) Patent Application Publication
(10) Pub. No.: US 2005/0034338 A1
(43) Pub. Date: Feb. 17, 2005

(54) Feature calendar

(76) Inventor: Sandra Edwards Footman, Silver Spring, MD (US)

Correspondence Address: Sandra Edwards Footman, #832, 815 Thayer Avenue, Silver Spring, MD, 20910, US

(21) Appl. No.: 10/640,991

(22) Filed: Aug. 14, 2003

(51) Int. Cl. G09D 3/00; G09F 3/04

(52) U.S. Cl. 40/107; 40/447

(57) ABSTRACT

The advantages of the Feature Calendar are that they eliminate the need for outdated hanging paper calendars. The Feature Calendar provides the consumer with the gift to use a good-sized 12×14-wall calendar that is flat, functions as a computer; which saves Appointments, Birthdays, and special occasions, it also tells time, and the Toon Bar displays cartoons into the Feature Calendar. It has sixteen easy to use input keys; two mini speakers used with an Alarm which switch has an On/Off button. The Feature Calendar runs itself smoothly, month to month and year to year.

### BACKGROUND OF THE INVENTION

The Feature Calendar invented Jan. 15, 1998. I Sandra Edwards Footman, after individually not being able to unearth a suitable home calendar, that would award me all the requirements for my family, I begin to picture what it would be like to contain a calendar that would take care of 99% of the common persons home calendar needs. The Feature Calendar offers that on a regular and continues basis, at the touch of a key.

The Feature Calendar is a vital home flat wall calendar, information center, appointment book, family planner. The Feature Calendar will eliminate the need for all wall hung paper calendars, by simply using the push of a key; all the Year's information will automatically appear on screen. All doctor appointments, vacation plans, family birthdays etc. will emerge at the touch of a key; another touch of a key will show the present month, date, and time for that year; and hangs on the wall like a picture.

The Feature Calendar takes the place of paper calendars by updating itself on a monthly and yearly basis. The Feature Calendar also maintains time; include a built in rotating clock. It has a fine slenderness throughout and the ability to function as a flat wall computer at the same time. Not only does it look like a mere calendar, its thinness leads one to think it would-be connected to the wall similar to a flat screen T.V. The Feature Calendar has sharp fine feature.

The Feature Calendar is slightly larger then the home paper calendar, the lower half for Information Keys, is 3″ inches. These keys help control the Feature Calendar for input of information. The measurement of the Feature Calendar is 12″ W×14″ L and 1/2 inch in depth.

### BRIEF SUMMARY OF THE INVENTION

The incentive of the Feature Calendar used by our new society of busy people helps facilitate the release of paper reminders written on calendars that are often ragged or misplaced in the mix up. The Feature Calendar detect special rendezvous input by the consumer such as Birthdays, special Holidays, special Family events, Meetings, and Appointments and is brought to the forefront at the press of a key.

While the Feature Calendar (sitting idol) working as a daily calendar with one month showing, and there is a future Appointment in two days, (48 hours). The Feature Calendar will sound off a Mini-Alarm Beeper, which the date on the Feature Calendar; will be highlighted; until day of the event, or until FIG. 18 (O K) key is pressed.

The Feature Calendar keyed information FIG. 13 key, pressed once (1 Day/12 Months), a Full (present-day) viewed, or press twice, twelve months displays itself for input of information; Use Arrow keys to pick from any of the twelve months to store Appointments, Birthdays etc. Letter and Number keys enter this information. Enter, FIG. 11 Family/Friends or key FIG. 12 Appointment/Time, FIG. 18 key (O K), keyed information has saved, and the present month and year are current.

The consumer if necessary can use a security device used within the Feature Calendar. By picking a four-digit number, this secures the FIG. 18 key (O K); bank Appointments, Birthdays, etc. In addition, saves the present month and year's information in place. If a four-digit number is not used; Using FIG. 18 key (O K), will still bring about the same results except; the information accumulated is not guaranteed to be erased at any time.

### BRIEF DESCRIPTION OF THE SEVERAL VIEWS OF THE DRAWING

FIG. 1 Wall view used as sample to flatness of depth of the Feature Calendar that is 1/2 inch in depth.

FIG. 2 Side view of Feature Calendar, Width 12″ Length 14″.

FIG. 3 Display the Days of the Week, Sunday through Saturday.

FIG. 4 Display the Numbers of the Month, 1-31.

FIG. 5 Prior Month viewed at the tap of a finger on that Month, the (O K) key returns the present screen.

FIG. 6 Next Month viewed at the tap of a finger on that Month, the (O K) key returns the present screen.

FIG. 7 Displayed Holiday (Inner Calendar) P.5 July 4.

FIG. 8 Revolving Time/Day/Month boxes, eight boxes, four at beginning of the Month, four at the end of the Month.

FIG. 9 Input Information Keys, sixteen keys used to update the Feature Calendar.

FIG. 10 Mini Alarm Speakers A and B, notifies consumer of important dates 48-hours in advance, then again day of event, by highlighting date.

FIG. 11 Key-Family/Friends once pressed and information to a Month and Year is input, press (O K) key to save.

FIG. 12 Key-Appointments/Time, once pressed and information to a Month and Year is input, press (O K) key to save. Twice pressed, displays choice of AM/PM use the Space Bar, then (O K) key.

FIG. 13 Key-1 Day/12 Month, pressed once display one full (present) day; pressed twice shows the full Years Calendar.

FIG. 14 Key-Right Arrow, Moves Right, through Month and Year.

FIG. 15 Key-Left Arrow, Moves Left, Month through and Year.

FIG. 16 Key-Vertical Arrow, Moves Up, Month through and Year.

FIG. 17 Key-Horizontal Arrow, Moves Down, Month through and Year.

### BRIEF DESCRIPTION OF THE SEVERAL VIEWS OF THE DRAWING (CONT)

FIG. 18 Key-(O K), Saves information, brings back information to present date, day and time.

FIG. 19 Key-Input Letters, four keys in all, three hold seven letters each; the last holds only five (V-Z). Tap key once for letter A, (O K) key to enter, tap five times for letter Z, (O K) key to enter.

FIG. 20 Key-Input Numbers, works with Appointments/Time the two keys of numbers each hold five numbers each, tap key once for 0, (O K) key to enter, tap the second key, once for 5, (O K) key to enter.

FIG. 21 Key-Space Bar, used in conjunction with keys Family/Friends, Appointments/Time and (1 Day/12 Months) has ability to Space during keying in information; also, Space Bar used to pick a Day within a Month. Space Bars also used to delete information.

FIG. 22 Key-Toon Bar, inserts pictures into the Feature Calendar, instead of keying in words Happy Birthday, the Toons key would produce pictures of Balloons, a fine Diner would appear as a Black Tie, a day at the beach displays the Sun.

FIG. 23 Full Year View, Uses Arrows to pick Month, Space Bar to desired Day, (O K) key, full screen opens.

FIG. 24 Press 1× (1 Day/12 Months) FIG. 13 key, displays present day.

FIG. 24A Displays information after input.

FIG. 25 Press 2× (1 Day/12 Months) FIG. 13 key, displays full year calendar. Input the last two numbers of the Year 2004-04 the New Year calendars displayed.

FIG. 26 Alarm On/Off; switch located on the lower right side of the Feature Calendar.

FIG. 27 Dates and Appointments scheduled; using the two Number keys; four Alphabet keys, information input in capital letters.

### DETAILED DESCRIPTION OF THE INVENTION

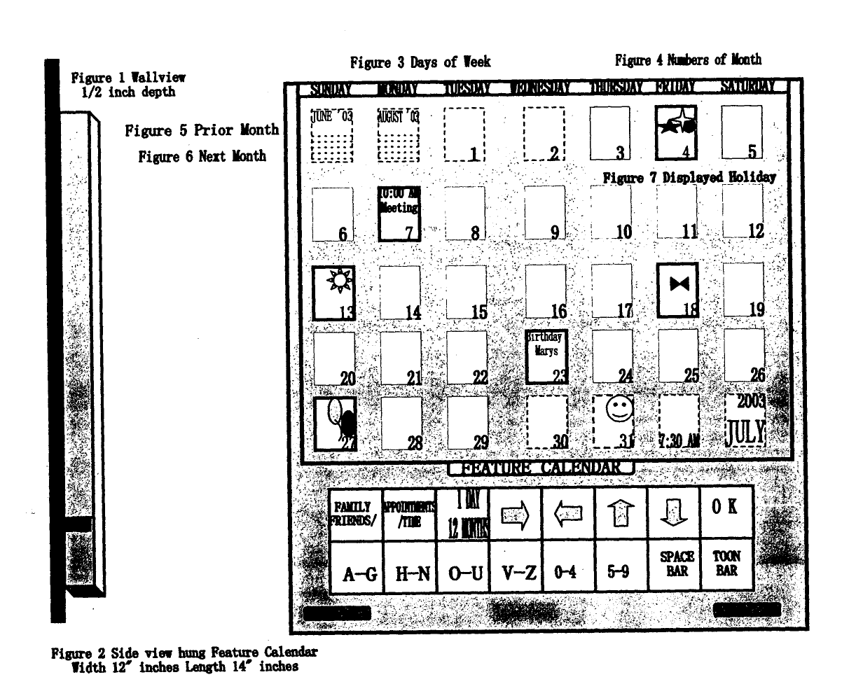

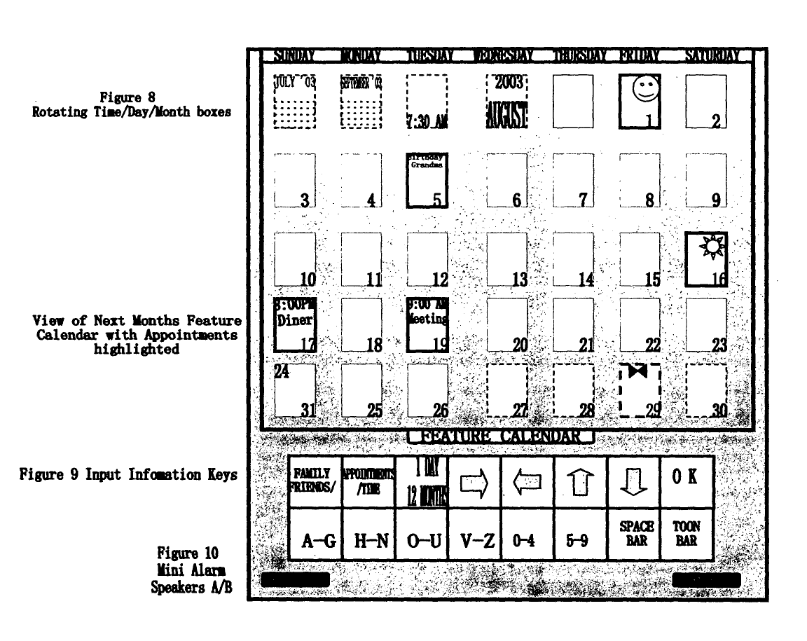

The wall displayed in FIG. 1, is used as an example of how flat and flawless the Feature Calendar is, its depth is only one-half (½) of an inch the Width is twelve Inches (12″) inches, Length of fourteen Inches (14″) inches, slightly wider and longer then the paper hanging calendar. The Feature Calendar's easily hung on the wall like a picture.

The Feature Calendar displays engraved capital letters of the days of the week, Sunday through Saturday on the top outer frame of the Feature Calendar. The numbers of the months displayed within the Feature Calendar itself are numbers from one through thirty-one (1-31). The prior month and the next month; is displayed at the tap of a finger on either month; gives one a full month view, to return to present screen press the FIG. 18 key (O K).

Holidays are highlighted forty-eight (48) hours in advance, this action is automatic, no action is necessary. The number of that calendar day will automatically light up; stays highlighted until midnight, night of Holiday.

There are eight (8) rotating boxes, four (4) at the beginning of the month; four (4) at the end of the month; those areas consistently rotate the Prior month, Next month, Time, and Present month name/Year as displayed items.

Sixteen keys; used to update the Feature Calendar; all serve their own functions, some more then one. Simplicity is most important when using computers on a daily basis.

### DETAILED DECRIPTION OF THE INVENTION

FIG. 10 Mini Alarm Speakers A/B are on the lower far left and right of the Feature Calendar; they notify the consumer of important dates forty-eight (48) hours in advance by giving off low but, accurate alarm every half hour. The date stays highlighted until the day of event. The Alarm is turned off two ways, the first is by pressing FIG. 18 (O K) key will stop the Alarm only until the Day of the event, appointment, Birthday etc . . . then it will reset itself and the Alarm will go off again; Day of the event. The second way, turn off the Alarm by moving the side button on the lower right side of Feature Calendar to Off switch; this will allow only the glow of the Appointed Day; when the day has passed, the highlighted Day/Number is back to normal.

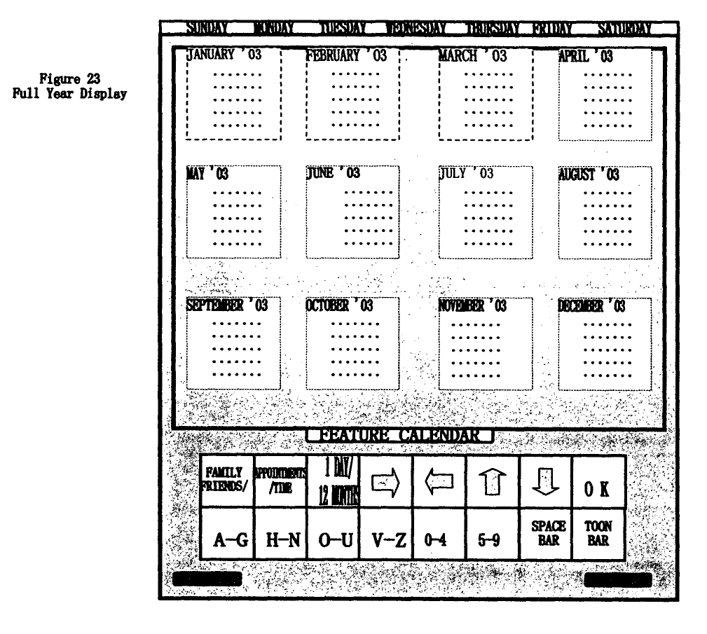

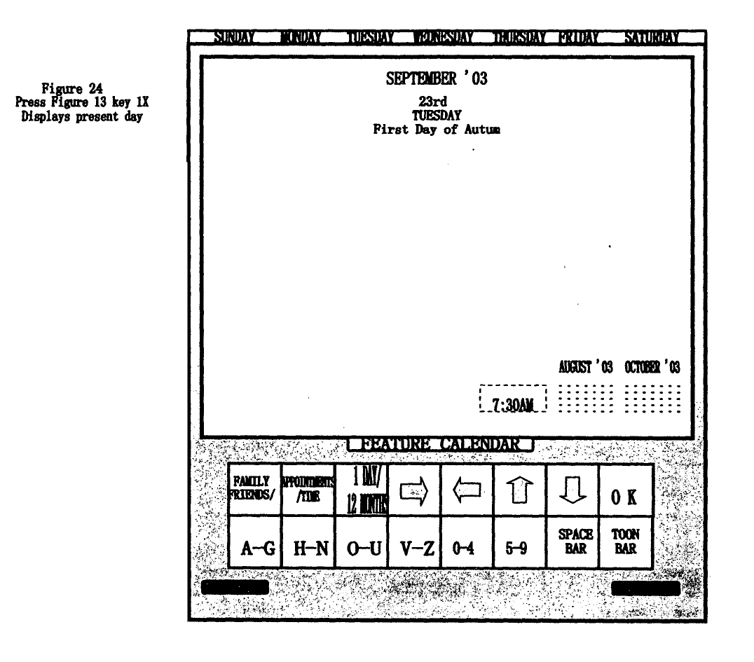

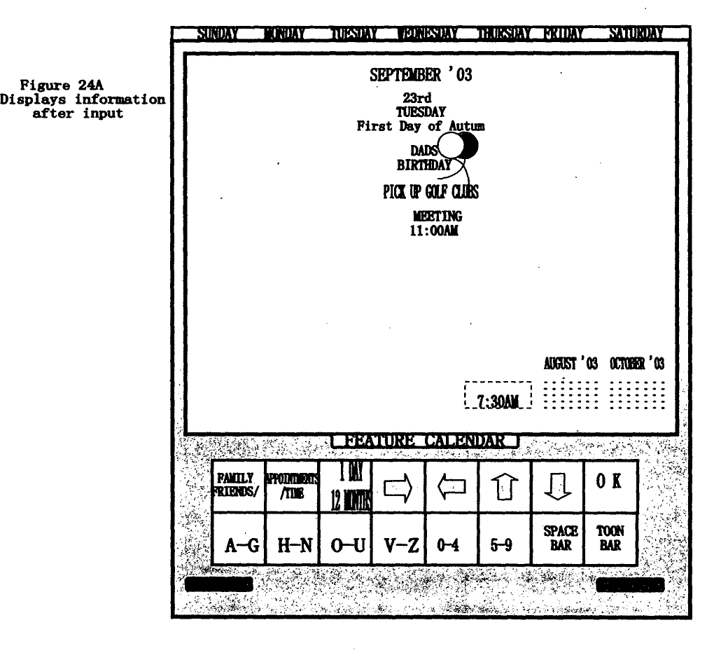

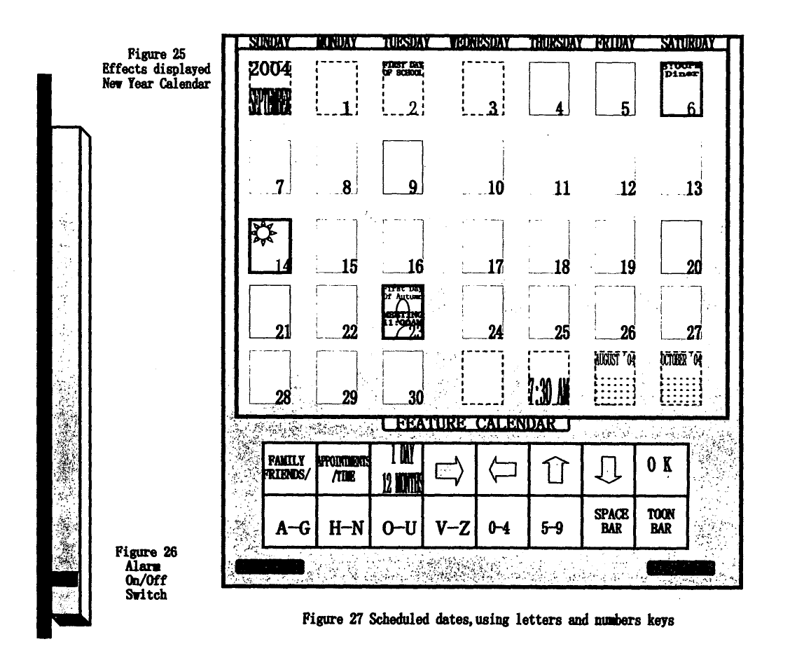

FIG. 11 key, (Family/Friends) used to help store Birthdays, Anniversaries, Special Days; of loved ones, to pick a Day or Month, tap FIG. 13 key (1 Day/12 Months), once to view the present Day. Tap Twice to view the Full Year, use FIGS. 14-17, use the Arrow keys to move up, down, left or right to the month desired; press FIG. 18 the (O K) key, month becomes a full screen; use FIG. 21 key the (Space Bar) to pick the day. FIG. 19, four keys (4) inputs Letters for typing in names and FIG. 20, the number keys for keying numbers. For same day use, FIG. 13 key, (1 Day/12 Months) tap once, the full screen for same day comes up; Type in the person's name, any information, to keep key FIG. 11 Family/Friends plus FIG. 18 (O K), saves and returns present day calendar.

### DETAILED DECRIPTION OF THE INVENTION

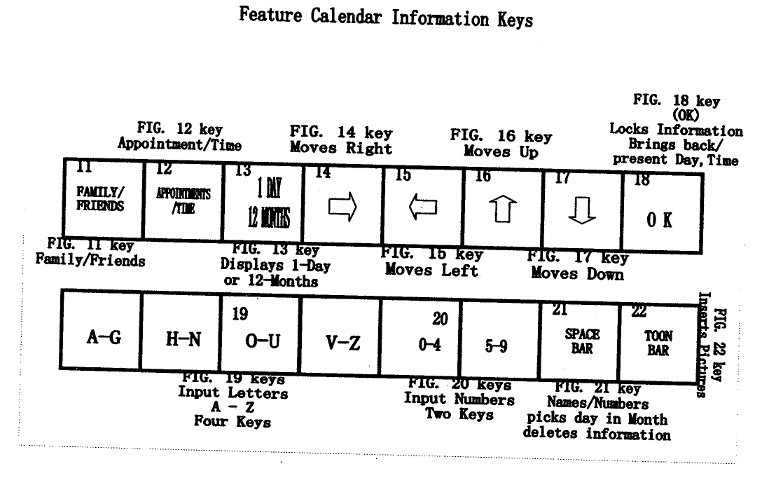

FIG. 12 key (Appointments/Time) used to help store Appointments, Family outings, Guest visits, Doctor Appointments. Pick a Day or Month, tap FIG. 13 key (1 Day/12 Months), once to view the present Day. Twice to view the Full Year, use FIGS. 14-17, the Arrow keys to move up, down left or right to the month desired; press FIG. 18 the (O K) key; that month becomes a full screen; use FIG. 21 key, the (Space Bar) to pick a day. Use FIG. 19 Four Keys (4) inputs Letters for typing in names also FIG. 20 the Number key for keying in Numbers. For same day use, enter FIG. 13 key, (1 Day/12 Months) tap once, the full screen for same day comes up; Type in the person's name, and information, to keep key FIG. 12 (Appointment/Time) plus FIG. 18 key (O K). FIG. 19 key Input Letters, and FIG. 20 key Input Numbers, EXAMPLE: MEETING 10:00 AM,

FIG. 12 key (Appointments/Time) pressed twice after the numbers are set in place will enable one to use the time mode of A.M. or P.M. to keep press FIG. 12 key (Appointments/Time) the information's saved.

FIG. 18 (O K) key is the most important key of all. It serves several purposes, secures information in, and brings the Feature Calendar back to present Day, Date, and Time. FIG. 18 (O K) key, works together with FIG. 11 key Family/Friends, FIG. 12 key Appointments, FIG. 13 key (1 Day/12 Months), FIG. 19 key Input Letters, FIG. 20 key Input Numbers, FIG. 21 key Space Bar, and FIG. 22 key Toon Bar. Permanently saving information, the consumer picks a Four-digit code; using FIG. 20 Number keys, then press FIG. 18 (O K) key. This permanently Locks in information.

### DETAILED DESCRIPTION OF THE INVENTION

FIG. 21 key Space Bar, by tapping, the Space Bar Twice will delete Letters, Numbers, or Appointments, and then you can retype information if necessary. Use FIGS. 14-17 the Arrow keys to move to the next line, or side from side, when finished hit the (OK) key to return to the present month.

FIG. 22 key Toon Bar, is used as calendar decorations, instead of typing in a persons name as a Birthday reminder, Balloons may be preferred. Diner reminders Black Ties selected, or a Trip to the Beach a picture of the Suns selected. The Full screens brought up by using the FIG. 13 key, FIGS. 14-17, FIG. 21; If choosing a different day; If present day tap once; Full screen appears. Press FIG. 11 or 12 key, Toon Bar, several Toons displayed, enter one then press FIG. 18 Key (O K), Toon is entered in on date chosen, at this time any other typed information is added to close; press again FIG. 18 key (O K), well return the present day calendar. 0023 FIG. 22 Full screen twelve-month displayed calendars, using the Arrow keys to pick a Month, Space Bar to pick the day, and the (O K) key creates the full Day screen ready for input of information. To use only the present Day display by tapping the FIG. 13 key once, for the Full twelve-month view tap twice.

FIG. 23 Full screen present-day calendar, all information for that day displayed. FIG. 13 key pressed once; the screen displays Month, Year, Date, Day of Week, and Holidays. In the lower right screen shows the Time, Prior Month, and Next Month.

### DETAILED DESCRIPTION OF THE INVENTION

FIG. 24 Full screen present-day calendar, all information for that day with new keyed in stored information. Using the FIG. 19 keys, to write, the FIG. 20 keys, for numbers, the Space bar to move left or right, up or down and the Toon Bar for instant cartoons, gives the Full screen present-day calendar its precise look. FIG. 18 (O K) key returns Full month present-screen.

FIG. 25 Feature Calendar effects shown on the outer body of the New Year after information changed by consumer, also displays its slenderness.

FIG. 26 Alarm On/Off switch, once the alarm is on the Feature Calendar settings for appointments highlighted, and the alarm will ring every half hour, forty-eight hours in advance. Turn the alarm off and the alarm will subside but, the highlighted date and will continue to stay lighted until midnight day of event.

FIG. 27 Shows FIGS. 19-20 keys for input; letters are in capital. The Feature Calendar changes automatically from year to year it has the ability of five years of saved information, which include Appointments, Birthdays, Diners, Family Vacations and Toons. Future information's input by tapping FIG. 13 twice, key in the last two numbers of the year desired; EXAMPLE: 2004 key in 0 4, New Year is displayed. Once you have completed your information, hit FIG. 18 (O K) key returns to present day screen.

1. An access system: computer flat wall calendar comprising:
a screen
a single station;
a information keys and
a data connected to said single station with a mini alarm, speakers, rotating clock,
wherein said access system includes:
means for stored up of information on said screen displaying a digital, a word, a picture; using said keys as signals to a single station brings about changes within said single station.
said means information keys used to input a data into said single station, also means for interrupting said single station; whereas mini alarm indicates the on switch used, said means for not interrupting said single station; whereas mini alarm indicates the off switch the said information still functions.

2. The access system of claim 1, wherein
said screen displays days of a week numbers of a month, present and prior months said keys returns to a present screen, whereas said screen includes revolving a month a time, thereby displays at the top left of said means access system four at entrance, also four at the lower right.

3. The access system of claim 1, wherein
said single stations unyielding data from input of said information keys responds to the insertion of correct information into a single station, through a mini alarm, said speakers, or said rotating clock.

4. The access system of claim 1, wherein
said information keys signal said single station indicating a digit of data to be included in said screen for display.

5. The access system of claim 1, wherein
said data on said screen is temporary, whereas said information key, and a personal four digit code, entered into said data saves all information.

6. The access system of claim 1, wherein
said mini alarm indicates to speaker A and B a result of signaling of said single station, displays result of a highlighted day.

7. The access system of claim 1, wherein
said exterior front consist, days of week, a display screen, predetermined multiple said information keys, and includes two said speakers.
